(19) United States
(12) Patent Application Publication
(10) Pub. No.: US 2011/0173595 A1
(43) Pub. Date: Jul. 14, 2011

(54) LANGUAGE-BASED MODEL FOR ASYNCHRONOUS OPERATIONS

(75) Inventors: Niklas Gustafsson, Redmond, WA (US); Artur Laksberg, Redmond, WA (US)

(73) Assignee: MICROSOFT CORPORATION, Redmond, WA (US)

(21) Appl. No.: 12/684,753

(22) Filed: Jan. 8, 2010

(51) Int. Cl. G06F 9/45

(52) U.S. Cl. 717/146

(57) ABSTRACT

The compilation of user code. Upon accessing the user code, the compiler determines that the user code includes at least one top-level asynchronous operation that is 1) to operate at a top-level of the stack of the programmed code, 2) that is programmed using a syntax for synchronous operations and 3) includes at least one indicator that the operation is to be asynchronous. The user code is then compiled such that the top-level asynchronous operation programmed in the syntax for synchronous operations is transformed into an asynchronous pattern suitable for the runtime environment.

### BACKGROUND

Application programming interfaces (APIs) that require waiting for a non-deterministically and relatively long time, such as accessing network resources or reading files from a storage media, in an application can be performed as synchronous or asynchronous operations.

Synchronous operations stall the application and other operations until the synchronous operation is complete. Synchronous syntax in computer programs is generally straightforward and familiar to developers, and many developers have little or no difficulties writing synchronous operations. An application using synchronous operations, however, can hold onto valuable computing resources while the synchronous operations complete, and thus synchronous operations can be very expensive if the network resources of files are not readily available.

Asynchronous operations, on the other hand, are used to avoid stalling the application and allow the computing resources to perform other useful work while the operation completes. For example, if an asynchronous operation pauses because the application is waiting for a response from a local storage media, a website server, or the like, the computing resources are released to perform other valuable work, and the asynchronous operation will resume with the computing resources after the application has received the file or download.

Managed environments, such as .NET available from Microsoft Corporation of Redmond, Wash., provide for several ways of defining and implementing asynchronous operations. A commonly used way is to use an Asynchronous Programming Model (APM). The APM defines an asynchronous operation as including two functions with the typical shape as:

IAsyncResult BeginXXX(<<args-1>>, AsynchronousCallback cb, object
state);
int EndXXX (IAsyncResult ar, <<args-2>>);

where “XXX” is the name of the operation, “args-1” is the list of the in- and ref-parameters, and “args-2” is the list of the out- and ref-parameters of the operation.

Although asynchronous operations provide the benefit of increased workflow, asynchronous operations as currently defined and implemented presents difficulties for many developers. One difficulty includes scaling, or providing for multiple requests, and chaining together requests in a loop as complications quickly arise as more requests are introduced. Also, many developers find composing larger asynchronous operations from existing APM-based operations to be a challenge. As the present trend toward integration of software applications with remote serves in an Internet cloud continues, there is a need for more asynchronous code.

### BRIEF SUMMARY

At least one embodiment described herein relates to the compilation of user code. Upon accessing the user code, the compiler determines that it includes at least one top-level asynchronous operation that is 1) to operate at a top-level of the stack of the user code, 2) that is programmed using a syntax for synchronous operations and 3) includes at least one indicator that the operation is to be asynchronous. The user code is then compiled such that the top-level asynchronous operation programmed in the syntax for synchronous operations is transformed into an asynchronous pattern suitable for the runtime environment.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 is a block diagram illustrating one example of a managed environment operating on the computing system of FIG. 1;

FIG. 3 is a block diagram illustrating an example of the managed environment, such as that illustrated in FIG. 2, implementing a language-based model for composing asynchronous operations according to one embodiment; and

FIG. 4 illustrates user code running in a runtime environment.

### DETAILED DESCRIPTION

In accordance with at least some embodiments described herein, the compilation of programmed code is described. Upon accessing the user code, the compiler determines that the user code includes at least one top-level asynchronous operation that is 1) to operate at a top-level of the stack of the user code, 2) that is programmed using a syntax for synchronous operations and 3) includes at least one indicator that the operation is to be asynchronous. The user code is then compiled such that the top-level asynchronous operation programmed in the syntax for synchronous operations is transformed into an asynchronous pattern suitable for the runtime environment.

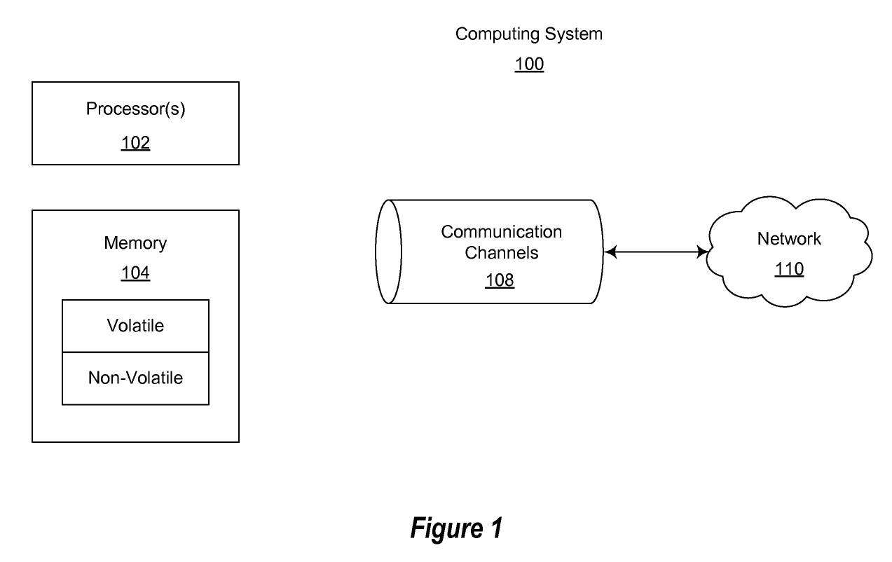

First, introductory discussion regarding computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other message processors over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include a computer program product having computer-readable media for carrying or having computer-executable instructions or data structures stored thereon. Such computer-readable media (or machine-readable media) can be any available media that can be accessed by a general purpose or special purpose computer. By way of example, and not limitation, such computer-readable media can comprise physical storage and/or memory media such as RAM, ROM, EEPROM, CD-ROM, DVD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

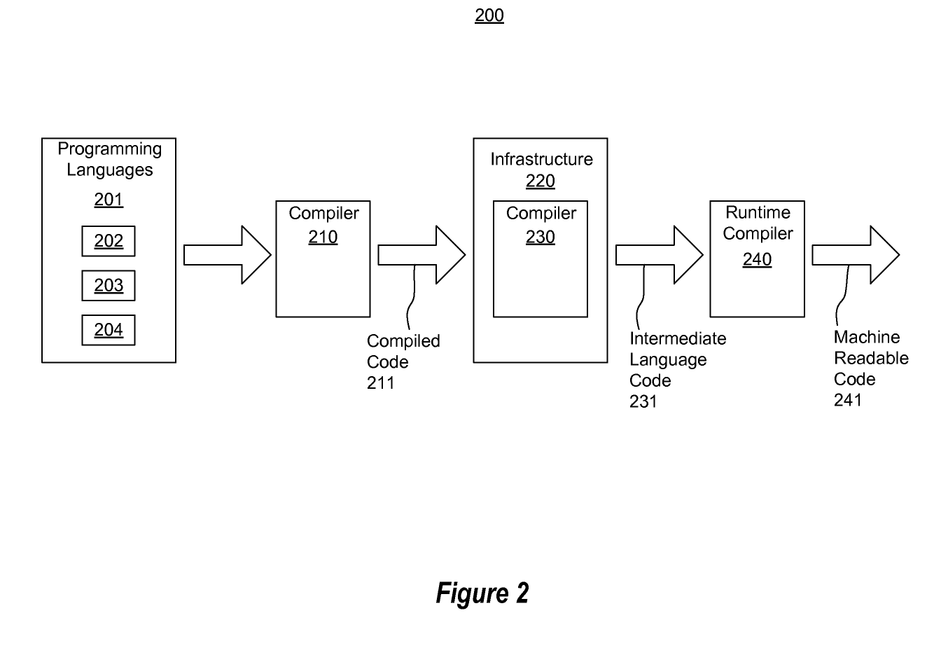

FIG. 2 illustrates an example managed, or runtime, environment 200 suitable for operation with the computing system 100. Particular current examples of managed environment frameworks include .NET from Microsoft and Java from Sun Microsystems, Inc. of Santa Clara, Calif., United States, as well as others. The managed environment 200 is configured to accept programs written in a high-level compatible code of one or more programming languages 201. For example, the managed environment can accept programs written in programming languages such as C# (C-sharp) code 202, a visual basic type language such as VB.NET code 203, and/or a JAVA type language (such as J-sharp) 204.

Compilers 210 are configured to compile each compatible code 202, 203, 204. The compiled code 211 can be provided to an infrastructure 220 that describes an executable code and a runtime environment that describes a number of runtimes. An example infrastructure is Common Language Infrastructure (CLI). The infrastructure includes a second compiler 230 that receives the compatible languages 211 and compiles them to a second and platform-neutral intermediate language 231, such as Common Intermediate Language (CIL). The intermediate language 231 is provided to a runtime compiler 240, such as the Microsoft Common Language Runtime (CLR) in the .NET framework, that compiles the intermediate language 231 into a machine readable code 241 that can be executed on the current platform or computing device.

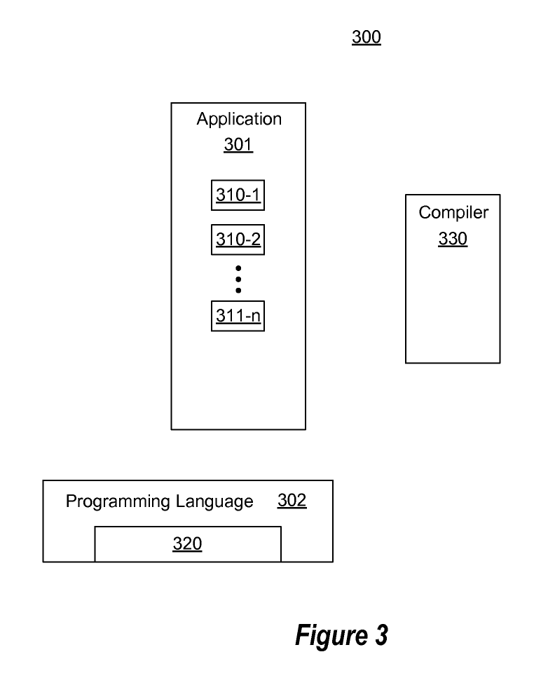

FIG. 3 illustrates a specific embodiment 300 of the managed environment 200, the specific embodiment 300 including a language-based model for composing asynchronous operations. The managed environment 300 includes an application or program 301 written in a high level programming language 302, such as Axum. The application 301 includes at least one, but often several, asynchronous operations 310-1 to 310-n. The high level programming language 302 includes support 320 for the asynchronous operations, such as language extensions or keywords, that permit the application 301 to be written in a synchronous style, or synchronous syntax. The language support 320 allows for the compiler to perform restructuring of the code into an asynchronous pattern such as an APM-based pattern. The syntax of the application 301 can include a synchronous look and feel with code comprising one or more synchronous operations but with asynchronous operations instead. The compiler 330 performs the code transformation and provides for identification of APM-compliant operations. The code transformations are designated to occur whenever the language support occurs. Appropriate language support for the compiler 330 can be efficiently implemented.

The language based model of FIG. 3 can be implemented through extending the programming language with a keyword, such as “async”, that can be used as a modifier on methods, delegate declarations, and lambda expressions. The language-based model provides several advantages over the standard APM. Among these advantages is that it provides a user-friendly syntax to compose the operations, which allows developers to program as if the operations were merely synchronous interfaces. To this, the model builds on existing, canonical, asynchronous patterns in .NET. The model also supports bridging other, non-conforming, patterns that can be composed in the same syntax. These and other features and advantages will become apparent through the examples listed below.

Whether the modifier is used with a class, structure, or an interface, async methods intrude on the namespace in which they are found. In an example, suppose that an async method “F” is authored by a user. For this information, the compiler 330 synthesizes methods “BeginF” and “EndF”. The name “F” is used to call the method synchronously, and “BeginF” and “EndF” are implementations of the APM for the operation “F”.

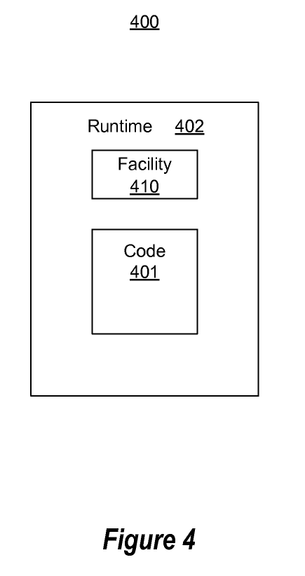

The ability to compose asynchronous operations comes from the ability to efficiently call asynchronous methods from other asynchronous methods, pause them and later resume them, effectively implementing a single-linked stack. Locals are hoisted and call sites transformed. In accordance with an embodiment described further below with respect to FIG. 4, the language-based model may even be performed at the top-level of the user code stack.

The language-based model can support features such as ordered compositions. An ordered composition includes calls to asynchronous methods that are serialized so that each async operation is completed before the next call in series will start.

An asynchronous method may contain yield points, or places where the method will pause, that can be represented by calls to other asynchronous methods. In one example, once an asynchronous method yields, the entire call chain yields and the outermost caller, an APM Begin method, returns an IAsyncResult instance with IsComplete==false. When the operation that caused the method to yield is completed, the entire call chain is resumed and executes until another yield point is reached. When there are no more yield points, the result of the outermost async method may be computed and the operation completed. At this point, IAsyncResult methodology to signal completion is employed and the code that started the operation can call the End method to retrieve the results of the operation. In situations where the results may be computed without ever yielding, Begin returns with CompletedSychronously==true.

An example implementation is as follows:

### Example 1

public async byte[ ] ReadFileToEnd(string path)
{

List<byte[ ]> data = new List<byte[ ]>( );
Stream stream =File.OpenRead(path);
byte[ ] next = new byte[1024 * 1024];
// The compiler will find BeginRead/EndRead and convert the APM
API
// into an asynchronous method call.
int numRead = stream.Read(next, 0, next.Length);
while (numRead > 0);
{

data.Add(next);
next = new byte[1024 * 1024];
numRead = stream.Read(next, 0, next.Length);

}
return FoldData(data); // Flatten the list into one long array.

}

Example 1 includes a set of “Read” operations composed serially, i.e., each Read is issued after the previous one has been completed. The code appears as a typical synchronous form, except for the declaration or keyword async. The compiler transforms the two instances of “stream.Read” into calls to the corresponding Begin/End pair by relying on the efficient callback version of the interfaces rather than by using WaitHandle or polling.

If after the first read operation issues and the read operation does not immediately complete, the method pauses, such as if it returns “temporarily” and gives up the stack frame it was using. This is similar to an iterator method yielding a value and then returning later on to produce the next one. The code of Example 1, however, does not output data—rather, it brings data into the method. After the read operation finishes, the method is resumed and moves on to the next statement, which is the loop. The method calls further read operations, each of which may pause and be resumed. If any of the operations finish promptly, such as without pausing, the compiler-generated code moves on without returning from the method. When all the operations are complete, the method calls “FoldData,” which is a synchronous method that takes the list of byte arrays and concatenates them.

Implementing ReadFileToEnd( ) using the APM and without the language-based support would include writing considerably more lines of code and would rely on an error-propagation model distinct from what is used with synchronous code. The language-based model provides for an easier and less error-prone method for writing asynchronous operations for many developers currently struggling with the APM.

Example 2 provides an exemplary code to read a set of files as a single asynchronous operation:

### Example 2

public async byte[ ][ ] ReadFiles(string [ ] paths)
{

byte [ ][ ] result . . .
for (int i = 0, i < paths.Length; i++)
{

//Calling an async method from an async method, the compiler
// provides support.
result[i] = ReadFiletoEnd(path);

}
return result;

}

Example 2 also calls a series of asynchronous operations (in this case defined as an asynchronous method) and lets the operations pause and resume as they are run. Just as in the Example 1, each operation is started once the previous operation is complete. Although each file can be read independently, the loop serializes the read operations. Note that when ReadFileToEnd pauses, ReadFiles also pauses—the pausing effect goes from the “leaf” operation all the way out to the outermost method, and the resumption starts at the outermost level and goes in toward the leaf.

Example 3 provides an exemplary invocation of an outermost asynchronous method, which can be ultimately composed.

### Example 3

IAsyncResult ar = BeginReadFiles(paths, ar =>

{

byte [ ][ ] fileContents = EndReadFiles(ar);
... // process file contents

});

In one example, the outermost frame of any asynchronous operation is started and treated as an APM, such as calling the operation and providing a callback. In one embodiment, however, even the outermost frame of the asynchronous operation may receive compiler assistance to restructure the asynchronous operation written in synchronous syntax into an asynchronous pattern. Thus, in this embodiment, the programmer need not have any familiarity at all with the asynchronous pattern. Instead, the programmer merely writes the code using synchronous syntax, and perhaps uses a simple marker (such as the async keyword) or other indication to designate when an operation is to be treated as an asynchronous operation.

FIG. 4 illustrates an environment 400 in which user code 401 operates within the context of a runtime 402. The runtime includes a deterministic facility 410 that permits the top level in the stack of the user code to have the synchronous syntax code. For instance, the deterministic facility 410 may be a single location that does the invocations and callback definitions that may be used by the asynchronous syntax. As an example, in the Axum programming language, all code has a well-defined and single top level called the “agent” or “actor”. Thus, the Axum runtime may be equipped with a single deterministic location that performs the Begin/End invocations used by the APM in a deterministic way. This information may be known to the compiler(s) at compilation time.

Thus, the compiler may know at compile time that the user code is going to be run in the Axum runtime that is equipped with the deterministic facility for invoking the asynchronous method calls. Thus, given this knowledge, the compiler may move forward with making transformations to the user code from the user code that is written in synchronous syntax into the more complex asynchronous operations that include the invocation of the Begin/End invocations of APM. Accordingly, if a programmer uses languages in which there is such a facility 410 available in the runtime 402, and in which the compiler is aware that the runtime has the facility, the programmer may make write code in synchronous syntax. The compiler may then make the transformation into asynchronous context.

For instance, if the programmer is using the Axum programming language, and if the intention of the programmer is clear that an operation should be asynchronously performed (e.g., the programmer includes the “async” marker), the compiler may make the appropriate transformation into asynchronous APM. The Axum agents thus become asynchronous agents and the compiler-transformed code is present and used throughout the stack, at the top level, and at all lower levels in the stack. Thus, the Axum programmer may write code that is much more readable and has no impact on control-logic structure. For instance, there are no restrictions on the control logic. Branching statements, looping, and all control functionality may be maintained without restriction. Thus, the control-logic structures remain highly efficient.

Delegate types, anonymous methods and lambdas can be defined as asynchronous by adding ‘async’ before the ‘delegate’ keyword:

public async delegate int Count(object obj);
Action<int> bar = async delegate(int x) { ... };
bar.BeginInvoke(...);
foo(async x => ...);

Some examples include a change to the binding of delegates created from asynchronous methods. For instance, the BeginInvoke( ) method is mapped directly to a call to BeginF, while the EndInvoke( ) method is mapped to EndF. In some examples the thread pool is not affected in the execution of BeginInvoke/EndInvoke on a delegate constructed from an asynchronous method. Further, an asynchronous delegate is bound to an asynchronous method by mapping the CreateAsyncInvoke method to CreateAsyncF. The delegate type can be augmented with the CreateAsyncInvoke method in a manner analogous to BeginInvoke and EndInvoke.

In cases of lambdas, the asynchrony can be inferred from context, in which case the async keyword is optional. In such circumstances, it may still be useful to ensure that an error is issued if the compiler cannot find a proper asynchronous overload.

In several examples, often near the leaves of a call chain, the application will encounter a feature that does not include an asynchronous method such as a native call, or an already existing APM API. In this case the application can include a “bridge routine” (such as a “hand-written” bridge routine) that may be called to bridge models. In some examples, the compiler will generate code to invoke any existing Begin/End pair as if it were an asynchronous method without a bridge routine.

Whether another compiled asynchronous method, or a hand-written bridge method, when found within an asynchronous method any invocation expression will cause the compiler to change its name lookup rules and use pattern-matching to look for an asynchronous version of an API.

In an example including a given method F( . . . ), the compiler will look for a BeginF/EndF pair or a CreateAsyncF method with a parameter signature that matches the one used in the invocation expression. The compiler 330 will give preference to the latter, but if either form is found, it will be transformed. In one example of a transformation, the method F is transformed to not be a sub-expression. A field to hold the IASyncResult is added to the class, and then the call site is transformed in one of any number of ways. If neither form is found, method F is invoked synchronously.

In cases where there are no Begin/End versions of the API, hand-coded bridge methods may allow creating a bridge using asynchronous interfaces based on callbacks.

The language based model also supports unordered compositions. In an unordered composition, each async operation is started and completed independently of the operations in the unordered composition. To support unordered composition of asynchronous operations, another keyword, such as “interleave,” can be added. In one example, unordered compositions can take the form of a static composition of sub-operations or a dynamic composition of sub-operations. In one example, interleave statements are used directly within the bodies of asynchronous methods.

One example of a static interleave includes the form of: interleave {op1; op2; op3;}

where op1-op3 are statements containing calls to asynchronous methods. The interleave construct finishes when all sub-operations are finished. Subsequent calls to asynchronous methods outside of the interleave operations are performed serially with respect to the unordered operations. For example, in the case of four operations represented with
interleave {op1; op2; op3;}
async op4;
op 4 is performed subsequent the completion of ops1-op3.

In one example, the dynamic interleave takes a form similar to for each:

interleave ( var x in enumeration )
{

op(x);

}

where op(x) is dependent on x and contains calls to asynchronous methods.

In example 4, ReadFiles are implemented in an unordered composition:

### Example 4

public async byte[ ][ ] ReadFiles(string [ ] paths)
{

List byte[ ]> result = new List<byte>( )
interleave (string path in paths)
{

//Calling an async method from an async method, the compiler
// provides support.
result.Add(ReadFile9path);

}
return result.ToArray( );

}

In one example, interleave is a construct between a serial and a parallel “loop” as it allows each iteration's outstanding asynchronous operation to proceed in parallel with all other operations created by the loop, but it will only run one “copy” of the code of the method at once. When the first iteration pauses, the next iteration is started. When the next operation is paused, the next yet is started until all have started. Once an operation can be resumed, only one operation is resumed and run until it pauses again (which may still involve background work being actively performed), after which another operation may be resumed. This example construct orchestrates the operations without introducing any true parallelism in the user code of the asynchronous method itself. Example framework solutions are also available to those developers that would prefer running the methods in parallel to each other such as TPL, which offer the means to distribute work and run it in parallel.

Examples can include several features relating to branching (goto, return), break, and continue statements. In one example, branch statements can be used within interleave blocks. Returning or branching to a location outside the block cancels all outstanding operations under the interleave statement. An occurrence of “break” nested within an interleave statement cancels all outstanding operations under the interleave statement and continues execution at the first statement after the interleave statement. An occurrence of “continue” nested within a dynamic interleave statement completes the “current iteration” of the interleave statement, but it leaves all other outstanding iterations intact.

Accordingly, the principles described herein permit for a compiler to identify potential errors that may occur at runtime due to operations of an agent that exceed the access permissions of the agent when accessing domain data and/or agent data. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for compiling user code, the method comprising:
an act of a compiler accessing programmed user code that is to run in a runtime environment;
an act of determining that the user code includes at least one top-level asynchronous operation that is 1) to operate at a top-level of a runtime stack, 2) that is programmed using a syntax for synchronous operations and 3) includes at least one indicator that the operation is to be asynchronous; and
compiling at least one of the at least one top-level asynchronous operation programmed in the syntax for synchronous operations into an asynchronous operation suitable for the runtime environment.

2. The method in accordance with claim 1, further comprising:
an act of determining that the runtime environment permits include a facility that permits even top-level asynchronous operations to be programmed in the syntax for synchronous operations with the at least one indicator that the operation is to be asynchronous.

3. The method in accordance with claim 1, wherein the at least one indicator that the operation is to be asynchronous includes at least one keyword.

4. The method in accordance with claim 1, wherein the programmed user code is programmed in the Axum programming language.

5. The method in accordance with claim 1, wherein the asynchronous operation suitable for the runtime environment includes asynchronous method calls.

6. The method in accordance with claim 5, wherein the asynchronous operation suitable for the runtime environment includes a callback definition.

7. The method in accordance with claim 4, wherein the asynchronous operation resulting from the act of compiling is consistent with the Asynchronous Programming Model.

8. The method in accordance with claim 1, wherein the asynchronous operation does not use data structures interpreted at runtime in order to enforce control flow.

9. The method in accordance with claim 1, further comprising:
an act of determining that the user code includes at least one lower-level asynchronous operation that is 1) to operate at a lower-level of a runtime stack, 2) that is programmed using a syntax for synchronous operations and 3) includes at least one indicator that the operation is to be asynchronous; and
compiling at least one of the at least one lower-level asynchronous operation programmed in the syntax for synchronous operations into an asynchronous operation suitable for the runtime environment.

10. The method in accordance with claim 1, wherein the programmed user code is in C-sharp programming language.

11. The method in accordance with claim 1, wherein the programmed user code is in VB.NET programming language.

12. The method in accordance with claim 1, wherein the runtime environment is included with an operating system configured for use with a computing system.

13. The method in accordance with claim 1, wherein the indicator that the operation is to be asynchronous is a keyword modifier for a method in which the operation is invoked in the programmed user code.

14. The method in accordance with claim 1, further comprising:
calling asynchronous operations from other asynchronous operations;
pausing and later resuming asynchronous operations; and
implementing a single-linked stack.

15. The method in accordance with claim 14 and further comprising supporting ordered compositions and unordered compositions

16. The method in accordance with claim 15, wherein the unordered compositions include starting and completing asynchronous operations independently of one another.

17. The method in accordance with claim 16, wherein unordered compositions are indicated with another indicator.

18. The method in accordance with claim 16, further comprising interleaving operations in the unordered composition.

19. A computer program product comprising one or more physical computer-readable media having thereon computer-executable instructions that are structured such that, when executed by one or more processors of a computing system, cause the computing system to perform a method for compiling user code, the method comprising:
determining that user code to be compiled includes at a top-level asynchronous operation that is to operate at a top-level of a runtime stack, even though the asynchronous operation is structured in synchronous syntax; and
compiling the top-level asynchronous operation from the synchronous syntax into an asynchronous pattern.

20. A method for compiling user code, the method comprising:
an act of a compiler accessing user code to be compiled and that is to ultimately run in a runtime environment;
an act of determining that the user code includes at least one top-level asynchronous operation that is 1) to operate at a top-level of a runtime stack, 2) that is programmed using a syntax for synchronous operations and 3) includes at least one keyword indicating that the operation is to be asynchronous;
an act of determining that the runtime environment permits include a facility that permits even top-level asynchronous operations to be programmed in the syntax for synchronous operations with the at least one indicator that the operation is to be asynchronous;
compiling at least one of the at least one top-level asynchronous operation programmed in the syntax for synchronous operations into an asynchronous operation suitable for the runtime environment;
an act of determining that the user code includes at least one lower-level asynchronous operation that is 1) to operate at a lower-level of a runtime stack, 2) that is programmed using a syntax for synchronous operations and 3) includes at least one indicator that the operation is to be asynchronous; and
compiling at least one of the at least one lower-level asynchronous operation programmed in the syntax for synchronous operations into an asynchronous operation suitable for the runtime environment.
